(19) United States
(12) Patent Application Publication
(10) Pub. No.: US 2006/0218201 A1
(43) Pub. Date: Sep. 28, 2006

(54) System and method for effecting thorough disposition of records

(75) Inventors: Windsor Wee Sun Hsu, San Jose, CA (US); Qingbo Zhu, Urbana, IL (US)

Correspondence Address: SAMUEL A. KASSATLY LAW OFFICE, 20690 VIEW OAKS WAY, SAN JOSE, CA, 95120, US

(73) Assignee: International Business Machines Corporation

(21) Appl. No.: 11/090,115

(22) Filed: Mar. 24, 2005

(51) Int. Cl. G06F 17/30

(52) U.S. Cl. 707/200

(57) ABSTRACT

A record disposition system classifies records into disposition groups based on an expiration date or disposition date of the records. For each disposition group, the system generates an encoding and decoding function. An encoding module uses the encoding function associated with the disposition group of a record to transform a record locator in an index entry associated with the record. To obtain the record from the index entry, a decoding module decodes the transformed record locator using the corresponding decoding function. The decoding function is stored to allow it to be individually disposed. When a disposition group of records are disposed, disposition of the associated decoding function is also carried out. A record locator in an index entry identifies a block in the expiration control block that identifies a corresponding record. In another embodiment, the encoding function includes an encryption algorithm.

### FIELD OF THE INVENTION

The present invention generally relates to the disposition of records. More particularly, the present invention pertains to a method of indexing records using WORM storage that enables the effective disposition of an index entry corresponding to an expired record.

### BACKGROUND OF THE INVENTION

Records such as electronic mail, financial statements, medical images, drug development logs, quality assurance documents, and purchase orders are valuable assets to a business that owns those records. The records represent much of the data on which key decisions in business operations and other critical activities are based. Having records that are accurate and readily accessible is vital to the business.

Records also serve as evidence of activity. Effective records are credible and accessible. Given the high stakes involved in maintaining the integrity of records, tampering with records can yield huge gains. Consequently, tampering with records must be specifically guarded against. Increasingly, records are stored in electronic form, making the records relatively easy to delete and modify without leaving a trace. Ensuring that these records are trustworthy, that is credible and irrefutable, is particularly imperative.

A growing fraction of records maintained by businesses or other organizations is subject to regulations that specify proper maintenance of the records to ensure the trustworthiness of records. The penalties for failing to comply with the regulations can be severe. Regulatory bodies such as the Securities Exchange Commission (SEC) and the Food and Drug Administration (FDA) have recently levied unprecedented fines for non-compliance with these records maintenance regulations. Bad publicity and investor flight as a result of findings of non-compliance cost businesses or organizations even more. As information becomes more valuable to organizations, the number and scope of such records keeping regulations is likely to increase.

An important requirement for trustworthy record keeping is ensuring that in a records review such as, for example, an audit, a legal or regulatory discovery, an internal investigation, all records relevant to the review can be quickly located and retrieved in an unaltered form. Consequently, records require protection from any modification during storage. In addition, some form of direct access mechanism such as an index is required to ensure that all records relevant to an inquiry can be discovered and retrieved in a timely fashion. One conventional technique for maintaining the trustworthiness of records includes storing records and index in write-once-read-many (WORM) storage.

When records expire, i.e., have outlived their usefulness to an organization or have passed any mandated retention period, it is crucial for the organization to perform disposition of the records. Otherwise, the records are subject to discovery. Discovery of records that have not undergone disposition can cause extensive damage or expense to an organization or individual. Disposition of records includes deleting the records. In some cases, disposition of records includes ensuring that the records cannot be recovered or discovered even with the use of data forensics. Such disposition is commonly referred to as shredding and can be achieved, for example, by physical destruction of the storage. For disk-based WORM storage, an alternative method of shredding is to overwrite the record more than once with specific patterns so as to completely erase remnant magnetic effects that may otherwise enable the record to be recovered through techniques such as, for example, magnetic scanning tunneling microscopy.

Records, however, are typically indexed on more than one field to facilitate search and retrieval. Consequently, all or portions of the records can be reconstructed from the corresponding index entries even after the records expire and have been disposed. For example, an index can include a dictionary of words occurring in a set of documents and posting lists for those words. The posting lists include a record locator such as an ID of a document (record) including the corresponding word. In some cases, the posting lists further include positional information of a word in a document.

By performing a join operation on a record locator in the index, an adversary can determine information contained in a record. In the case of a full-text index with positional information of words in documents, an entire document can be reconstructed from the full-text index even after the original document has undergone disposition. Consequently, it is imperative to dispose of all the index entries associated with records that have expired.

An arbitrary index entry, however, cannot typically be disposed at the time a record corresponding to the index entry expires because a unit of disposition tends to be much larger than an index entry. For example, disposition of data stored in a WORM optical disk is typically performed by physically destroying the entire disk. In disk-based WORM storage, metadata such as, for example, an expiration date is required for each disposition unit. To reduce the amount of metadata storage required, the disposition unit is specified as relatively large.

In general, an index entry is likely to be much smaller than a disposition unit. Consequently, an index entry cannot be disposed until all other entries within the disposition unit have expired. However, index entries are organized based on an index key and are not clustered on an expiration date. Thus, conventional disposition approaches expose an index entry to potential discovery for a relatively long time.

What is therefore needed is a system, a service, a computer program product, and an associated method for disposition of a record and an associated index entry. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for disposition of a record and an associated index entry. To insert a record into an index, a classification module of the present system classifies the record into a disposition group based on a similar criterion such as, for example, an expiration date or a disposition date of the record. For each disposition group, the present system generates an encoding function and a decoding function. An encoding module of the present system transforms a locator of the record using a generated encoding function and stores the transformed record locator in an index entry. To locate a record using an index entry, a decoding module of the present system decodes the transformed record locator using a generated decoding function.

The decoding function for each disposition group is stored by itself in at least one disposition unit. When a disposition group of records is disposed, the corresponding decoding function for that group is also disposed. After the decoding function has been disposed, record locators for the disposition group of records cannot be decoded. Consequently, the index entries for the disposition group of records have effectively been disposed. In one embodiment, the corresponding encoding function is also similarly disposed.

In another embodiment, additional decoy encoding functions and decoy decoding functions are stored to further obfuscate reconstruction of a record from one or more index entries by an adversary.

In a further embodiment, the present system utilizes an expiration control block for each disposition group. Instead of directly identifying a record, the record locator in an index entry identifies a block in the expiration control block that identifies the corresponding record. The expiration control block is stored by itself in at least one disposition unit. The locators of records in the same disposition group are clustered together in the expiration control block rather than distributed with the corresponding index entries. When the records in the disposition group are disposed, the expiration control block is also disposed. Consequently, the index entries for the disposition group of records are effectively disposed because the index entries cannot be associated with the records.

In yet another embodiment, the encoding function includes an encryption algorithm. The present system generates an encryption key for each disposition group. The encryption key is stored by itself in at least one disposition unit. The encryption algorithm generates an encrypted record locator by encrypting the record locator and record key in an index entry with the encryption key. The encrypted record locator is stored in place of the record locator in the index entry. When the records in a disposition group are disposed, the encryption key is also disposed. Consequently, the index entries for the disposition group of records are effectively disposed because the index entries cannot be associated with the records.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a record disposition system of the present invention can be used;

FIG. 2 is a block diagram of the high-level architecture of the record disposition system of FIG. 1;

FIG. 3 is a process flow chart illustrating a method of operation of the record disposition system of FIGS. 1 and 2 in classifying a record into a disposition group;

FIG. 4 is a process flow chart illustrating a method of operation of the record disposition of system of FIGS. 1 and 2 in inserting a record into an index;

FIG. 5 is a process flow chart illustrating a method of operation of the record disposition system of FIGS. 1 and 2 in retrieving a record using an index;

FIG. 6 is a schematic illustration portraying the operation of the record disposition system of FIGS. 1 and 2 in decoding the encoded record locator;

FIG. 7 is a schematic illustration portraying the operation of the record disposition system of FIGS. 1 and 2 in decoding an encrypted record locator; and

FIG. 8 is a schematic illustration portraying the operation of the record disposition system of FIGS. 1 and 2 in decoding a record locator encoded by an expiration control block.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Disposition group: a set of records grouped together based on a common criterion such as, for example, expiration date.

Record: an item of data such as a document, file, image, etc.

Index: a means for quickly finding a record by a record key.

Index entry: a representation of a record in the index including a record key and a record locator.

Record locator/pointer: a means for identifying and locating a record such as, for example, the record ID, an address of where the record is stored, etc.

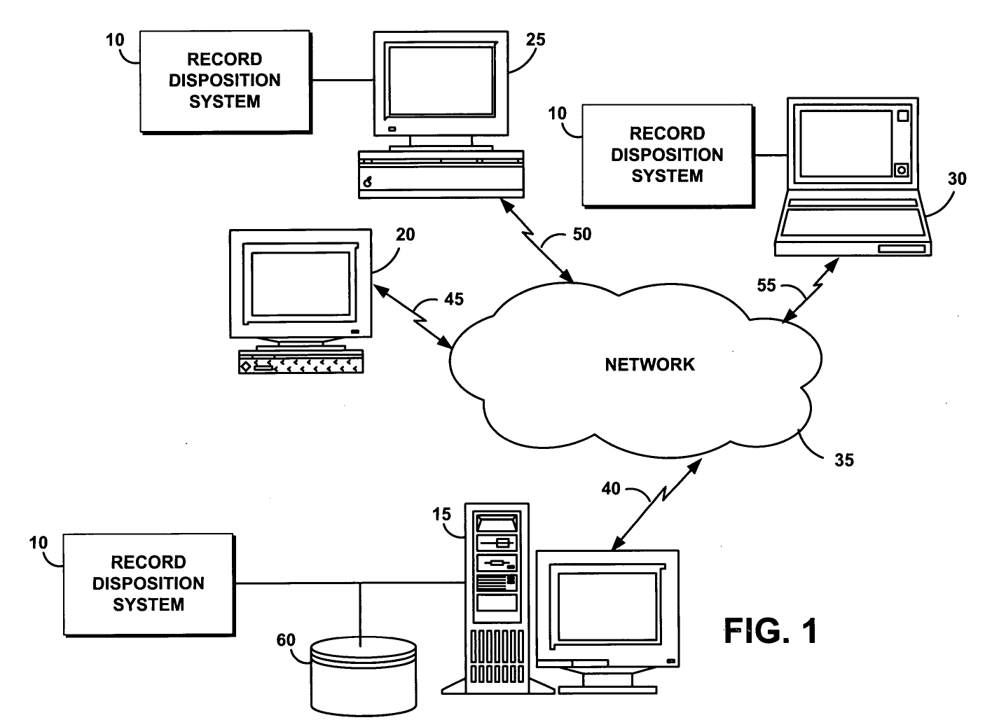

FIG. 1 portrays an exemplary overall environment in which a system, a service, a computer program product, and an associated method for thorough disposition of records (the “record disposition system 10” or the “system 10”) according to the present invention may be used. System 10 includes a software programming code or a computer program product that is typically embedded within, or installed on a host server 15. Alternatively, system 10 can be saved on a suitable storage medium such as a diskette, a CD, a hard drive, or like devices.

Users, such as remote Internet users, are represented by a variety of computers such as computers 20, 25, 30, and can access the host server 15 through a network 35. Computers 20, 25, 30 each include software that allows the user to interface securely with the host server 15. The host server 15 is connected to network 35 via a communications link 40 such as a telephone, cable, or satellite link. Computers 20, 25, 30, can be connected to network 35 via communications links 45, 50, 55, respectively. While system 10 is described in terms of network 35, computers 20, 25, 30 may also access system 10 locally rather than remotely. Computers 20, 25, 30 may access system 10 either manually, or automatically through the use of an application.

System 10 enables disposition of records and associated index entries stored on one or more storage devices 60. Alternatively, system 10 enables disposition of records and associated index entries stored within the structure of system 10. In one embodiment, the storage device 60 is a WORM storage device. System 10 can be used either locally or remotely in, for example, a directory in an operating system for organizing files, a database index, a full-text index, or any other data organization method. Data stored in the storage device 60 may be accessed by system 10 on server 15 or via system 10 on computers such as computer 25 or computer 30.

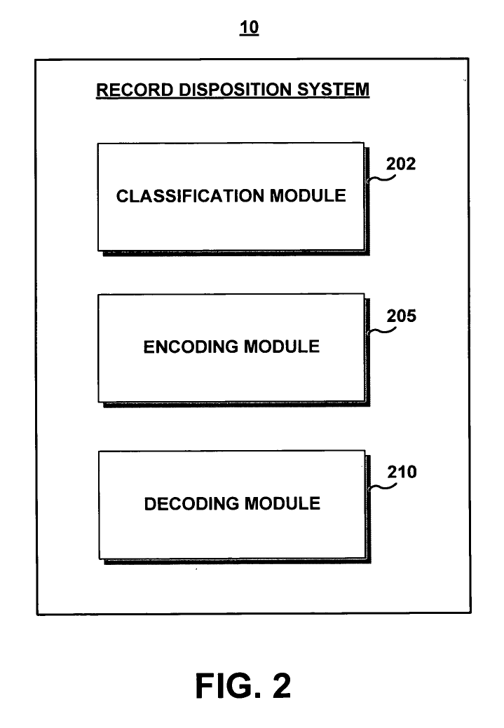

FIG. 2 illustrates a high-level architecture of system 10. System 10 includes a classification module 202, an encoding module 205 and a decoding module 210. The classification module 202 groups records into disposition groups based on a similar criterion such as, for example, an expiration date or a disposition date of the records. Prior to transformation by system 10, each index entry includes a key and a record locator. The encoding module 205 encodes the record locator when it is stored with the index entry. The transformed index entry includes a key and an encoded record locator. The decoding module 210 decodes the encoded record locator such that the record associated with the index entry can be located.

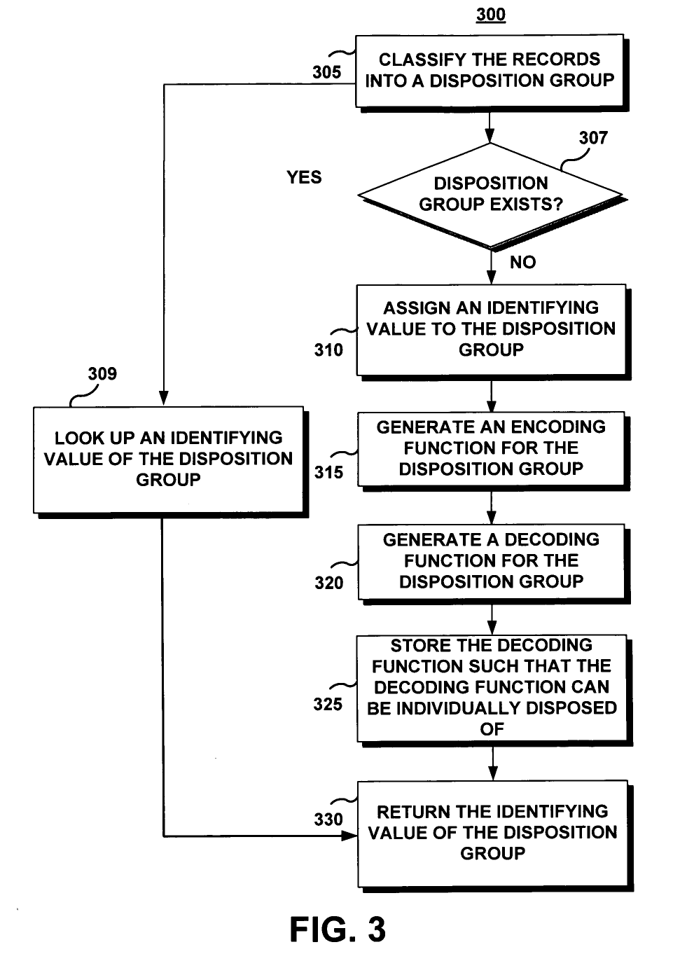

FIG. 3 is a process flow chart for a method 300 of system 10 in classifying a record into a disposition group. System 10 classifies records into a disposition group (step 305) by, for example, an expiration date of the records. If the disposition group does not exist (step 307), system 10 creates it by assigning an identifying value to the disposition group such as, for example, a group key (step 310). Next, system 10 generates an encoding function (step 315) for the disposition group and a decoding function (step 320) for the disposition group. System 10 stores the decoding function in such a manner that the decoding function can be individually disposed such as, for example, by itself in at least one disposition unit (step 325). In one embodiment, the encoding function is also stored so that it can be individually disposed. At step 330, the value identifying the disposition group is returned. If the disposition group exists (step 307), system 10 looks up a value identifying the disposition group (step 309) and returns the value (step 330).

In one embodiment, an expiration date is associated with each disposition unit. The expiration date can be extended but not shortened. A disposition unit can be disposed only after its expiration date. In such an embodiment, the expiration date of a disposition unit containing the decoding function for a disposition group is set to the expiration date of the records in the disposition group.

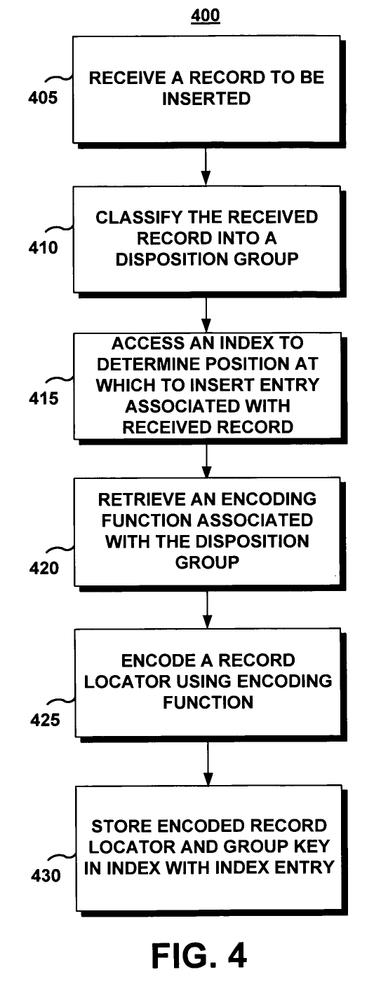

FIG. 4 is a process flow chart for a method 400 of system 10 in inserting a record into an index. System 10 receives a record to be inserted into an index (step 405). System 10 classifies the received record into a disposition group using method 300 (step 410). System 10 accesses the index to determine a position in the index to insert an index entry associated with the received record (step 415). System 10 retrieves an encoding function associated with the disposition group of the received record (step 420). The encoding module 205 encodes a locator of the received record using the encoding function (step 425). The encoded record locator and group key of the disposition group are stored in the index entry in the index (step 430).

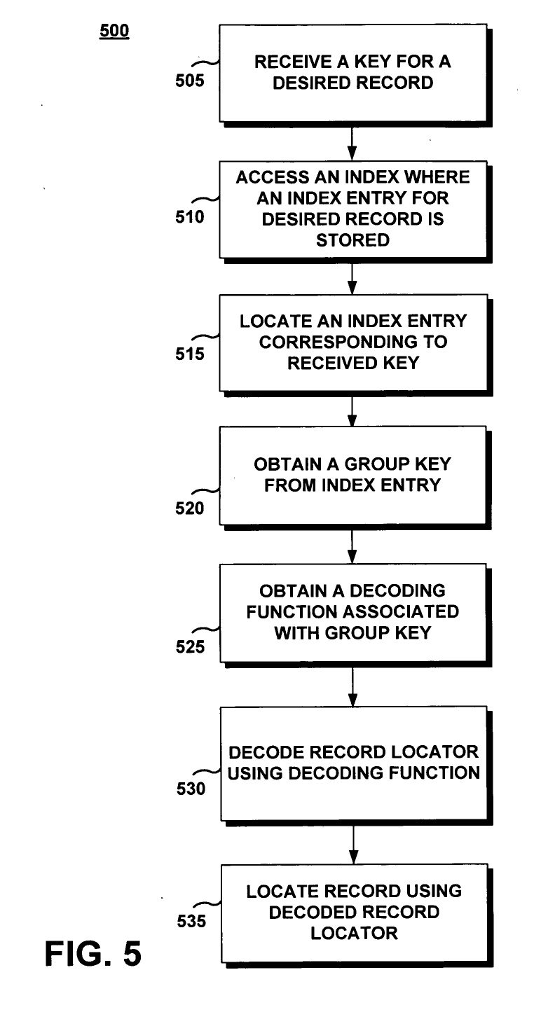

FIG. 5 is a process flow chart illustrating a method 500 of system 10 in retrieving a record using an index. System 10 receives a key for a desired record (step 505). System 10 accesses an index in which an index entry for the desired record is stored (step 510). System 10 locates an index entry corresponding to the received key (step 515). The located index entry identifies a record, but the record locator is encoded. The decoding module 210 obtains a group key for an associated disposition group from the index entry (step 520). The decoding module 210 obtains a decoding function associated with the disposition group by using the group key (step 525). The decoding module 210 decodes the record locator using the decoding function (step 530). System 10 locates the desired record using the decoded record locator (step 535).

In one embodiment, system 10 stores multiple pairs of encoding and decoding function for each disposition group. System 10 selects a pair of encoding and decoding function associated with the disposition group of the received record. System 10 encodes a locator of the received record using the selected encoding function. System 10 identifies the selected pair of encoding and decoding functions in an index entry associated with the received record. To retrieve the record, system 10 uses the identified selected decoding function to decode the encoded record locator. In another embodiment, additional decoy index entries and additional decoy record locators are stored in the index to further obfuscate reconstruction of a record from one or more index entries by an adversary.

When a disposition group of records is disposed, the corresponding decoding function for that group is also disposed. After the decoding function has been disposed, record locators for the disposition group of records cannot be decoded. Consequently, the index entries for the disposition group of records have effectively been disposed. In one embodiment, the corresponding encoding function is also disposed. Disposing the encoding function is useful in situations such as, for example, where the encoding function could be used to derive the decoding function.

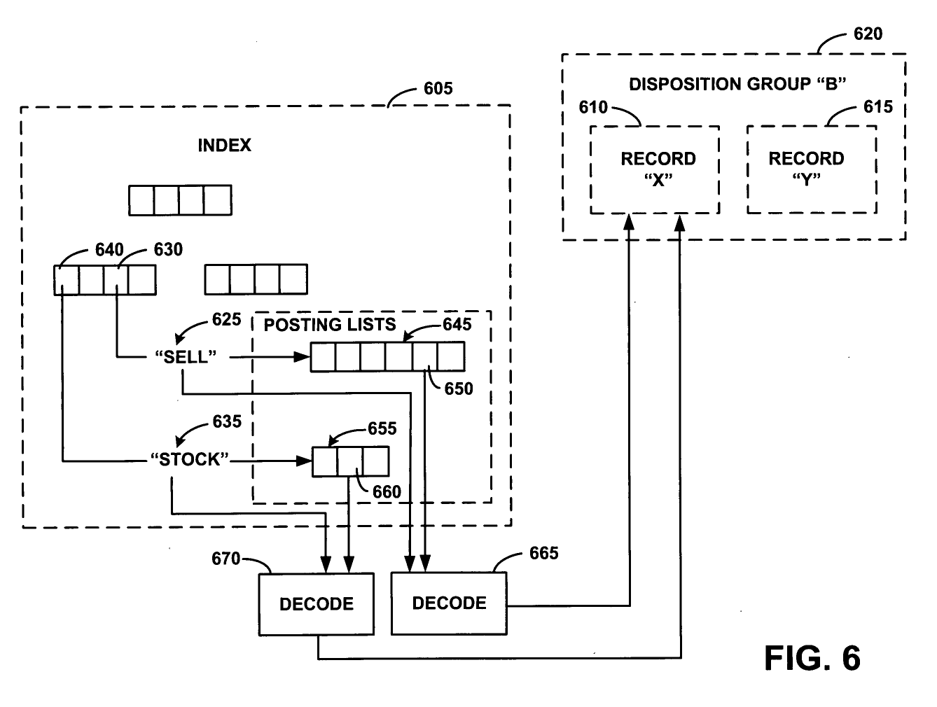

FIG. 6 illustrates, in diagram form, the performance of system 10 in an exemplary index 605. A record “X” 610 and a record “Y” 615 form a disposition group “B” 620. A key “sell” 625 (referenced as key “sell” 625) is stored in index location 630. Another key such as the word “stock” 635 (referenced as key “stock” 635) is stored in index location 640. Record “X” 610 includes the key “sell” 625 and the key “stock” 635. In this example, the key “sell” 625 occurs many times; locators of records including the key “sell” are further accessed in a posting list 645. A locator of record “X” 610 for the key “sell” 625 is located at posting cell 650. Locators of records including the key “stock” 635 are accessed in a posting list 655. A locator for record “X” 610 for the key “stock” 635 is located at posting cell 660.

In a conventional index, record locators in the posting cell 650 and the posting cell 660 “point” directly to record “X” 610. In System 10, the record locators are encoded. Consequently, the record locator in posting cell 650 requires decoding by the decoding module 210 as represented by a decode 665 before record “X” 610 can be located using the locator in the posting cell 650. Similarly, the record locator in the posting cell 660 requires decoding by the decoding module 210 as represented by a decode 670 before record “X” 610 can be located using the locator in the posting cell 660.

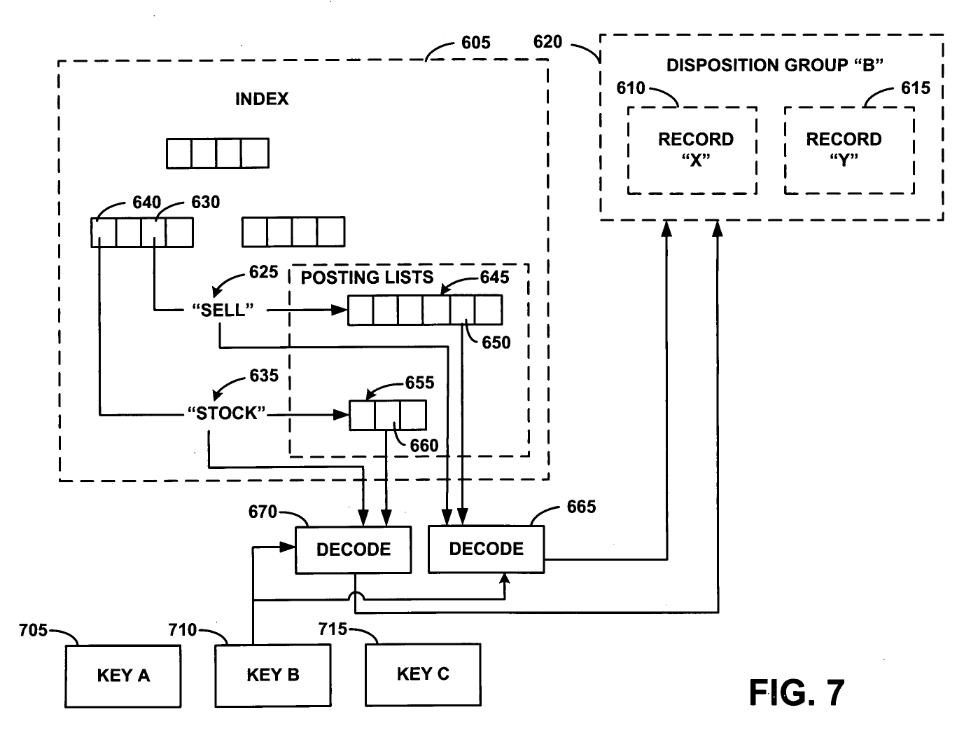

In an embodiment, the encoding module 205 includes an encryption function and the decoding module 210 includes a corresponding decryption function, as illustrated in FIG. 7. Each disposition group includes an associated encryption key and an associated decryption key such as decryption key A, 705 (key A, 705), decryption key B, 710 (key B, 710), or decryption key C, 715 (key C, 715). In this embodiment, the classification module 202 generates an encoding function and a decoding function for a disposition group by generating an encryption key and a decryption key. The encoding module 205 encodes the record locator at step 425 of method 400 (FIG. 4) by encrypting the record locator and record key with an encryption key associated with the disposition group of the record to generate an encrypted record locator. The encrypted record locator and appropriate disposition group key are stored in the index entry in the index. The decoding module 210 uses a decryption key associated with the appropriate disposition group to decrypt the encrypted record locator and obtain the original locator of the associated record.

In another embodiment, the record locator is encrypted by using an encryption key that includes the record key and an encryption key associated with the disposition group of the record. The record locator is decrypted by using a decryption key that includes the record key and a decryption key associated with the disposition group of the record.

As illustrated in FIG. 7, record “X” 610 and record “Y” 615 are associated with the disposition group B, 620. Furthermore, the decryption key B, 710, is associated with disposition group B, 620. The decoding module 210 uses the decryption key B, 710, in decode 665 and decode 670 to obtain the locator of record “X” 610 for “sell” 625 and the locator for record “X” 610 for “stock” 635”.

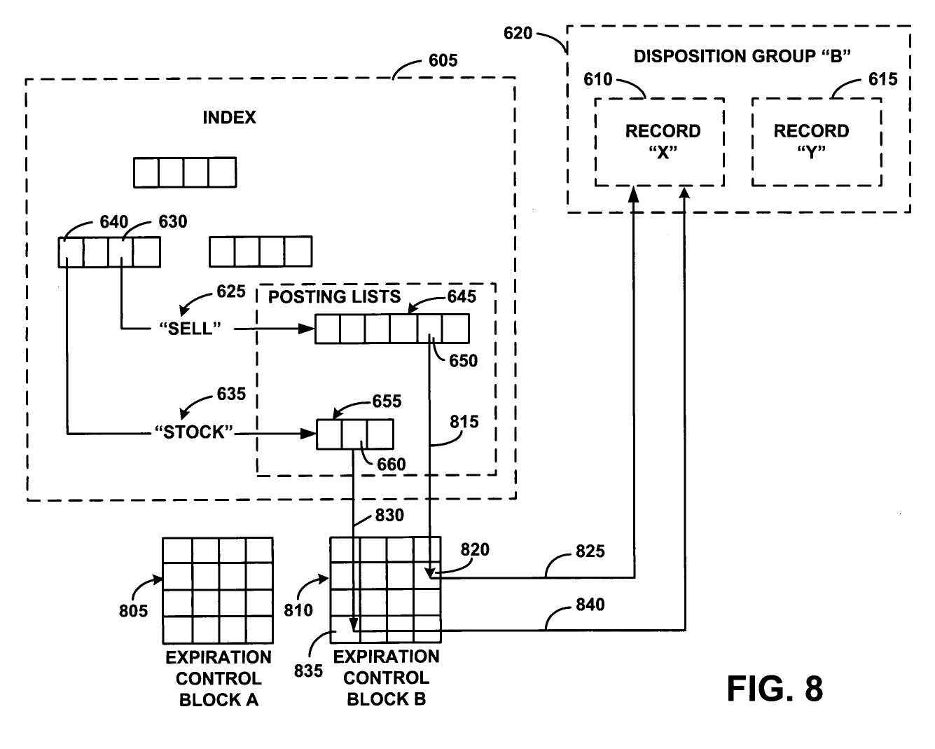

FIG. 8 illustrates an embodiment in which system 10 uses an expiration control block as the encoding function and the decoding function. System 10 generates an expiration control block for each disposition group such as, for example, an expiration control bock A, 805, and an expiration control block B, 810. Each expiration control block is stored by itself in at least one disposition unit. Rather than storing an actual record locator in the index, system 10 stores an indirect record locator in the index. The indirect locator identifies an entry in the expiration control block where the actual record locator is stored. Each expiration control block serves as an indirect table for locators of records in the same disposition group.

For example, the expiration control block B 810 is associated with disposition group B 620. The locator in posting cell 650 (an indirect locator 815) for the key “sell” 625 identifies an entry 820 in the expiration control block B 810. A direct locator 825 in entry 820 identifies record “X” 610. Similarly, the locator in posting cell 660 (an indirect locator 830) for the key “stock” 635 identifies an entry 835 in the expiration control block B 810. A direct locator 840 in entry 840 identifies record “X” 610.

It is to be understood that the specific embodiments of the invention that have been described are merely illustrative of certain applications of the principle of the present invention. Numerous modifications may be made to the system and method for thorough disposition of records described herein without departing from the spirit and scope of the present invention.

Moreover, while the present invention is described for illustration purpose only in relation to WORM storage, it should be clear that the invention is applicable as well to, for example, any type of storage. It should also be noted that WORM storage refers generally to storage that does not allow stored data to be modified, and may take several forms including WORM storage systems that are based on rewritable magnetic disks and those that do not allow stored data to be modified for a specified period of time after the data is written. Furthermore, while the present invention is described for illustration purpose only in relation to an index configured as a tree with posting lists, it should be clear that the invention is applicable as well to, for example, any type of index or other record organization technique.

What is claimed is:

1. A method for disposing of records, comprising:
storing a record;
creating an entry in an index in WORM storage to locate the record;
receiving a command to dispose of the record;
disposing of the record; and
disposing of the entry in the index in the WORM storage to prevent reconstruction of the record.

2. The method according to claim 1, wherein creating the entry in the index includes encoding the record locator in the entry with an encoding function; and
wherein disposing of the index entry includes disposing of a decoding function that corresponds to the encoding function.

3. The method according to claim 1, wherein creating the entry in the index includes classifying the record into a disposition group and encoding the record locator in the entry with an encoding function associated with the disposition group; and
wherein disposing of the index entry includes waiting for all the records in the disposition group to be disposed of, and further disposing of a decoding function that corresponds to the encoding function.

4. The method according to claim 2, further comprising:
receiving a request to find a desired record;
looking up the index to locate an entry associated with the desired record; and
decoding the record locator in the entry with the decoding function associated with the desired record.

5. The method according to claim 1, wherein creating the entry in the index includes:
classifying the record into a disposition group; and
if the disposition group does not exist:
creating the disposition group;
generating an encoding function for the disposition group;
generating a decoding function for the disposition group;
using the generated encoding function to encode a record locator in the entry in the index; and
storing the decoding function so that the decoding function is individually disposed of;
if the disposition group exists:
looking up an encoding function associated with the disposition group;
using the encoding function to encode a record locator in the entry in the index.

6. The method according to claim 3, wherein classifying the record comprises classifying by expiration dates.

7. The method according to claim 2, wherein encoding the record locator includes encrypting the record locator with an encryption key.

8. The method according to claim 2, wherein encrypting the record locator includes encrypting the record locator and a record key with an encryption key.

9. The method according to claim 2, wherein encoding the record locator includes using indirection through an expiration control block.

10. The method according to claim 2, wherein storing the decoding function includes storing the decoding function in at least one disposition unit.

11. The method according to claim 5, further including disposing of the decoding function associated with a corresponding disposition group upon disposition of all the records in the disposition group.

12. The method according to claim 1, further including storing additional decoy index entries and additional decoy record locators in the index.

13. A computer program product including a plurality of executable instruction codes on a computer-readable medium, for disposing of records, comprising:
a first set of instruction codes for storing a record;
a second set of instruction codes for creating an entry in an index in WORM storage to locate the record;
a third set of instruction codes for receiving a command to dispose of the record;
a fourth set of instruction codes for disposing of the record; and
a fifth set of instruction codes for disposing of the entry in the index in the WORM storage to prevent reconstruction of the record.

14. The computer program product according to claim 13, wherein the second set of instruction codes creates the entry in the index by encoding the record locator in the entry with an encoding function; and
wherein the fifth set of instruction codes disposes of the index entry by disposing of a decoding function that corresponds to the encoding function.

15. The computer program product according to claim 13, wherein the second set of instruction codes creates the entry in the index by classifying the record into a disposition group and by encoding the record locator in the entry with an encoding function associated with the disposition group; and
wherein the fifth set of instruction codes disposes of the index entry by waiting for all the records in the disposition group to be disposed of, and by further disposing of a decoding function that corresponds to the encoding function.

16. The computer program product according to claim 14, further comprising:
a sixth set of instruction codes for receiving a request to find a desired record;
a seventh set of instruction codes for looking up the index to locate an entry associated with the desired record; and
an eight set of instruction codes for decoding the record locator in the entry with the decoding function associated with the desired record.

17. A system for disposing of records, comprising:
a storage for storing a record;
a classification module for creating an entry in an index in WORM storage to locate the record;
the classification module receiving a command to dispose of the record;
the classification module disposing of the record; and
the classification module disposing of the entry in the index in the WORM storage to prevent reconstruction of the record.

18. The system according to claim 17, wherein the classification module creates the entry in the index by encoding the record locator in the entry with an encoding function; and
wherein the classification module disposes of the index entry by disposing of a decoding function that corresponds to the encoding function.

19. The system according to claim 17, wherein the classification module creates the entry in the index by classifying the record into a disposition group;
further comprising an encoding module that encodes the record locator in the entry with an encoding function associated with the disposition group; and
wherein the classification module disposes of the index entry by waiting for all the records in the disposition group to be disposed of, and by further disposing of a decoding function that corresponds to the encoding function.

20. The system according to claim 18, further comprising:
the classification module receiving a request to find a desired record;
the classification module looking up the index to locate an entry associated with the desired record; and
further comprising a decoding module that decodes the record locator in the entry with the decoding function associated with the desired record.
